(19) United States
(12) Patent Application Publication
(10) Pub. No.: US 2022/0413541 A1
(43) Pub. Date: Dec. 29, 2022

(54) OPERATION DEVICE

(71) Applicant: KABUSHIKI KAISHA TOKAI RIKA DENKI SEISAKUSHO, Aichi (JP)

(72) Inventors: Yoshihiro SHIMIZU, Aichi (JP); Yusuke USUI, Aichi (JP)

(21) Appl. No.: 17/777,794

(22) PCT Filed: Nov. 10, 2020
(86) PCT No.: PCT/JP2020/041981

§ 371 Date: May 18, 2022

(30) Foreign Application Priority Data
Nov. 20, 2019 (JP) 2019-209308

(51) Int. Cl. G05G 9/00; G05G 1/02; G05G 1/01; H01H 15/06

(52) U.S. Cl. CPC G05G 9/00; G05G 1/02; G05G 1/01; H01H 15/06

(57) ABSTRACT

An operation device includes at least one operation knob on which at least one detection area is set, a contact detection unit to detect contact of a user with the at least one detection area, an operation detection unit to detect an operation performed on the at least one operation knob, and a control unit that controls a controlled object by a combination of a detection area in which contact has been detected and an operation performed on an operation knob including the detection area, and when a predetermined operation on the operation knob is detected while contact remains undetected, the control unit selects a control related to the operation knob from the combination and controls the controlled object.

### CROSS-REFERENCES TO RELATED APPLICATIONS

The present patent application claims the priority of Japanese patent application No. 2019/209308 filed on Nov. 20, 2019, and the entire contents of Japanese patent application No. 2019/209308 are hereby incorporated by reference.

### TECHNICAL FIELD

The present invention relates to an operation device.

### BACKGROUND ART

A power window device is known which includes drive means respectively moving plural window glasses of a vehicle, an operation means to drive the drive means, and a control means that controls the drive means to move the window glasses to open or close according to an operation performed on the operation means (see, e.g., Patent Literature 1).

The operation means of this power window device includes plural window switches corresponding to the plural window glasses. Then, when a special operation, which is an operation different from a normal operation of individually operating the plural window switches, is performed, the control means controls the drive means to move all window glasses so that these window glasses are moved at different movement timings.

### CITATION LIST

### Patent Literature

Patent Literature 1: JP 2016/124329 A

### SUMMARY OF INVENTION

### Technical Problem

If the power window device disclosed in Patent Literature 1 is configured such that, e.g., the plural window switches are provided with contact detection sensors and detection of contact is also used in combination with an operation performed on the window switch to control various drive of the window glasses, and when an operation is performed in a state in which the sensor is malfunctioning or a glove is worn, contact may be undetected and the window glass may not be driven, causing a decrease in convenience.

It is an object of the invention to provide an operation device which can suppress a decrease in convenience.

### Solution to Problem

An operation device in an embodiment of the invention comprises:
at least one operation knob on which at least one detection area is set;
a contact detection unit to detect contact of a user with the at least one detection area;
an operation detection unit to detect an operation performed on the at least one operation knob; and
a control unit that controls a controlled object by a combination of a detection area in which contact has been detected and an operation performed on an operation knob comprising said detection area, and when a predetermined operation on an operation knob is detected while contact remains undetected, the control unit selects a control related to said operation knob from the combination and controls the controlled object.

### Advantageous Effects of Invention

According to an embodiment of the invention, it is possible to provide an operation device which can suppress a decrease in convenience.

### BRIEF DESCRIPTION OF DRAWINGS

FIG. 1A is a top view showing an operation device in the first embodiment.

FIG. 1B is a cross-sectional view showing the operation device when a cross section cut along line I(b)-I(b) of FIG. 1A is viewed in a direction of arrow.

FIG. 2 is a block diagram illustrating the operation device in the first embodiment.

FIG. 3A is a top view showing a vehicle on which the operation device in the first embodiment is mounted.

FIG. 3B is an explanatory diagram illustrating a door for explaining a position of the operation device in the first embodiment.

FIG. 4 is an explanatory diagram for explaining a predetermined operation on the operation device in the first embodiment.

FIG. 5 is a flowchart showing an operation of the operation device in the first embodiment.

FIG. 6 is an explanatory diagram for explaining a predetermined operation on the operation device in the second embodiment.

FIG. 7 is a flowchart showing an operation of the operation device in the second embodiment.

FIG. 8A is an explanatory diagram illustrating that a predetermined operation on the operation device in the third embodiment is an operation that continues for not less than a predetermined time.

FIG. 8B is an explanatory diagram illustrating that the predetermined operation on the operation device in the third embodiment is an operation following a predetermined procedure.

FIG. 9 is an explanatory diagram illustrating the operation device in the fourth embodiment that includes plural operation knobs.

### DESCRIPTION OF EMBODIMENTS

### SUMMARY OF THE EMBODIMENTS

An operation device in embodiments has at least one operation knob on which at least one detection area is set, a contact detection unit to detect contact of a user with the at least one detection area, an operation detection unit to detect an operation performed on the at least one operation knob, and a control unit that controls a controlled object by a combination of a detection area in which contact has been detected and an operation performed on an operation knob having said detection area, and when a predetermined operation on an operation knob is detected while contact remains undetected, the control unit selects a control related to said operation knob from the combination and controls the controlled object.

When an operation performed on the operation knob is the predetermined operation, this operation device can select the control related to the operation knob and control the controlled object even if contact is undetected. Therefore, it is possible to suppress a decrease in convenience as compared to when such a configuration is not adopted.

### First Embodiment

### General Configuration of an Operation Device 1

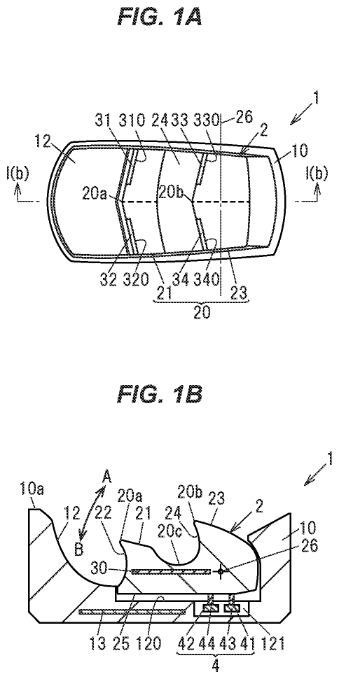

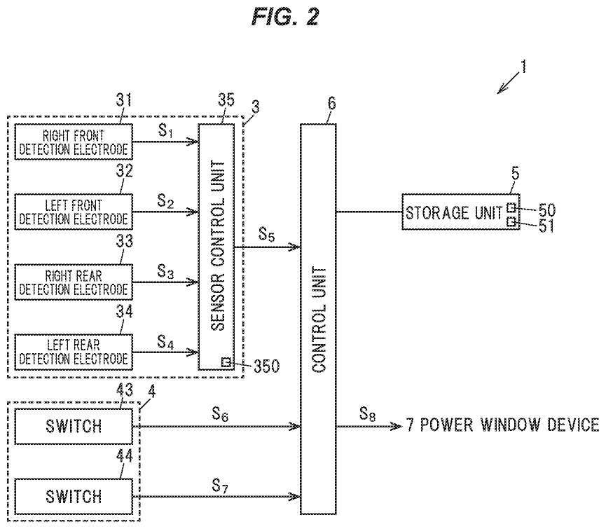

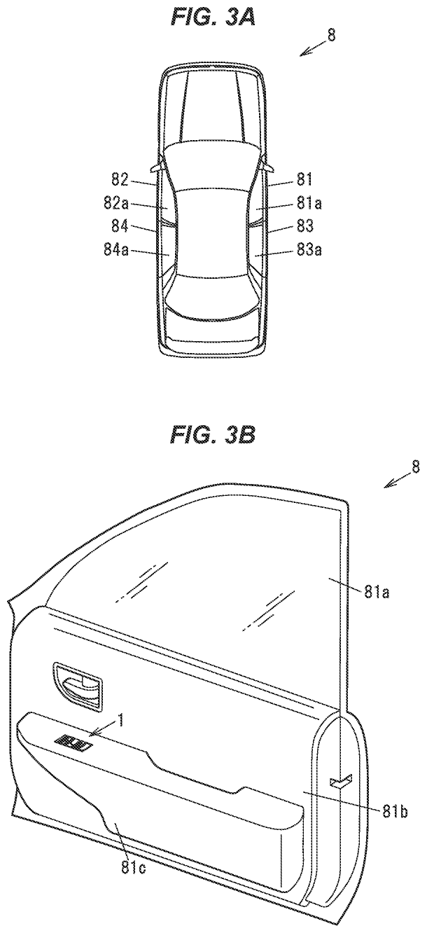

FIG. 1A is a top view showing an operation device, and FIG. 1B is a cross-sectional view when the operation device is cut along a longitudinal direction. FIG. 2 is a block diagram illustrating the operation device. FIG. 3A is a top view showing a vehicle on which the operation device is mourned, and FIG. 3B is an explanatory diagram illustrating a door for explaining a position of the operation device. In each drawing of the embodiments described below; a scale ratio may be different from an actual ratio. In addition, in FIG. 2, flows of main signals and information are indicated by arrows.

The operation device 1 in the first embodiment is configured to drive a window of a door close to a user's seat when a predetermined operation is performed even if contact with the operation knob is not detected.

In particular, as shown in FIGS. 1A to 2, the operation device 1 has at least one operation knob on which at least one detection area is set, a contact detection unit 3 to detect contact of a user with the at least one detection area, an operation detection unit 4 to detect an operation performed on the at least one operation knob, and a control unit 6 that controls a controlled object by a combination of a detection area in which contact has been detected and an operation performed on an operation knob having said detection area, and when a predetermined operation on the operation knob is detected while contact remains undetected, the control unit selects a control related to said operation knob from the combination and controls the controlled object.

The at least one operation knob in the first embodiment is one operation knob 2. As shown in FIG. 1A, this operation knob 2 has a first detection area 310, a second detection area 320, a third detection area 330 and a fourth detection area 340 as the at least one detection area. As shown in FIG. 2, the controlled object in the first embodiment is a power window device 7. The predetermined operation in the first embodiment is an operation that continues for not less than a predetermined time.

As an example, the operation device 1 is arranged in a right-hand drive four-door vehicle 8, as shown in FIGS. 3A and 3B, in more particular, the operation device 1 is arranged on an armrest 81c attached to a door trim 81b of a driver's side door 81 of the vehicle 8, as shown in FIG. 3B.

The operation device 1 is configured to be capable of instructing the power window device 7 to open and close windows 81a-84a on doors 81-84. That is, the plural windows mentioned above are the windows 81a-84a. The operation device 1 may be arranged on a door other than the driver's side or may be arranged in a two-door vehicle.

A groove 24 is formed on a surface 20 of the operation knob 2, and the operation knob 2 is divided at the groove 24 into a front-end operation region 21 corresponding to the front seat windows 81a, 82a and a rear-end operation region 23 corresponding to the rear seat windows 83a, 84a.

The front-end operation region 21 has the first detection area 310 corresponding to the driver's seat window 81a and the second detection area 320 corresponding to the front passenger seat window 82a. The rear-end operation region 23 has the third detection area 330 corresponding to the window 83a. behind the driver's seat and the fourth detection area 340 corresponding to the window 84a behind the front passenger seat. That is, the operation regions mentioned above are the first to fourth detection areas 310-340.

### Configuration of the Operation Knob 2

The operation knob 2 is formed of a resin material. The operation knob 2 is arranged in a recessed portion 12 of a main body 10, as shown in FIG. 1B. The recessed portion 12 has a curved surface so that an operating finger of the user is guided downward from an upper surface 10a of the main body 10. The operation knob 2 is attached to the main body 10 so as to rotate inside the recessed portion 12 in an arrow A direction and an arrow B direction about a shaft 26. The arrow A direction is a direction in which the operation knob 2 is pulled up. The arrow B direction is a direction in Which the operation knob 2 is pushed down.

As shown in FIG. 1A, the groove 24 of the operation knob 2 when viewed from above is formed to have a curved shape rather than a linear shape. In addition, as shown in FIG. 1B, the groove 24 when viewed in a cross section cut along line I(b)-I(b) is curved from a rear end of the front-end operation region 21 to a vertex 20b of the rear-end operation region 23. The shape of the groove 24 from the vertex 20b to a lower surface 20c allows the user to easily perform a pull-up operation by hooking the operating finger.

The operation knob 2 also has a front surface 22 having a shape curved from a vertex 20a on the front side toward a lower surface 25 of the operation knob 2. The front surface 22 has a shape which is recessed toward the inside of the operation knob 2, from the vertex 20a toward the rear end. The shape of the front surface 22 also allows the user to easily perform a pull-up operation by hooking the operating finger, in the same manner as the groove 24.

Since the operation knob 2 has the first to fourth detection areas 310-340 as described. above, the four windows 81a-84a can be operated by one knob and the size is small.

### Configuration of the Contact Detection Unit 3

As shown in FIG. 1A, the contact detection unit 3 in the first embodiment is a capacitive touch sensor that detects contact of a detection target with the first to fourth detection areas 310-340 of the operation knob 2.

As shown in FIG. 2, the contact detection unit 3 has a right front detection electrode 31 to a left rear detection electrode 34, and a sensor control unit 35 that determines contact of the detection target based on first to fourth output signals S₁-S₄ acquired from the right front detection electrode 31 to the left rear detection electrode 34. The sensor control unit 35 is arranged on a sub-substrate 30. The sub-substrate 30 is arranged in the operation knob 2. The detection target is the operating finger of the user.

The right front detection electrode 31 to the left rear detection electrode 34 are formed of a conductive metal material. The right front detection electrode 31 and the left front detection electrode 32 are arranged at a boundary between the front-end operation region 21 of the surface 20 and the front surface 22. The right front detection electrode 31 and the left front detection electrode 32 are exposed on the front-end operation region 21 and the front surface 22 so that the operating finger of the user conies into contact therewith at the time of performing a push-down operation or a pull-up operation on the operation knob 2. The right rear detection electrode 33 and the left rear detection electrode 34 are arranged at a boundary between the rear-end operation region 23 of the surface 20 and the groove 24. The right rear detection electrode 33 and the left rear detection electrode 34 are exposed on the rear-end operation region 23 and the groove 24 so that the operating finger of the user comes into contact therewith at the time of performing a push-down operation or a pull-up operation on the operation knob 2.

The first detection area 310 is a portion of the right front detection electrode 31 exposed on the operation knob 2. The second detection area 320 to the fourth detection area 340 are portions of the left front detection electrode 32 to the left rear detection electrode 34 exposed on the operation knob 2.

The first detection area 310 corresponds to the right front window 81a of the vehicle 8. The second to fourth detection areas 320-340 correspond to the left front window 82a, the right rear window 83a and the left rear window 84a. By performing a push-down operation or a pull-up operation while touching the right front detection electrode 31, the user can open or close the window 81a. Likewise, by performing an operation while touching any of the left front detection electrode 32 to the left rear detection electrode 34 at the time of a push-down operation or a pull-up operation, the user can open and close the window corresponding to the detection area in which the contact has been detected.

The right front detection electrode 31 to the left rear detection electrode 34 have a long shape as shown in FIG. 1A, but it is not limited thereto. The right front detection electrode 31 to the left rear detection electrode 34 are also decorative components to decorate the operation knob 2.

The sensor control unit 35 is a microcomputer composed of a CPU (=Central Processing Unit) performing calculation and processing, etc., of the acquired data according to a stored program, and a RAM (=Random Access Memory) and a ROM Read Only Memory) as semiconductor memories, etc. The ROM stores a program for operation of the sensor control unit 35. The RAM is used as a storage area to temporarily store calculation results, etc. The sensor control unit 35 also has, inside thereof, a means to generate a clock signal and operates based on the clock signal. This clock signal is synchronized with the control unit 6.

The sensor control unit 35 is, e.g., an electrostatic capacitance sensor IC (=integrated. Circuit). The contact detection unit 3 is configured as a self-capacitance type touch sensor in which capacitance increases when the operating finger of the user conies into contact with the right front detection electrode 31 to the left rear detection electrode 34. The sensor control unit 35 has an electrostatic capacitance threshold value 350 in the RAM or the ROM and determines that there is contact of the operating finger of the user when capacitance of not less than the electrostatic capacitance threshold value 350 is detected. In this regard, the contact detection unit 3 is not limited to the self-capacitance type touch sensor and may be a mutual-capacitance type touch sensor or another type of touch sensor.

The first to fourth output signals S₁-S₄ acquired by the sensor control unit 35 from the right front detection electrode 31 to the left rear detection electrode 34 are analog signals. The sensor control unit 35 determines whether or not there is contact for each of the right front detection electrode 31 to the left rear detection electrode 34, and outputs the result as a detection signal S₅ to the electrically connected control unit 6. The detection signal S₅ is a digital signal. The sensor control unit 35 is connected to the control unit 6 by a flexible cable.

The sensor control unit 35 is mounted on the sub-substrate 30 (shown in FIG. 1B) which is arranged in the operation knob 2. The sub-substrate 30 is a printed circuit board on which wiring and electrode pads, etc., are provided. The right front detection electrode 31—the left rear detection electrode 34 are electrically connected to the sensor control unit 35 via the electrode pads or wiring formed on the sub-substrate 30.

Since the contact detection unit 3 is arranged on the operation knob 2 and sends the detection result to the main body 10 side using digital signals instead of analog signals, it is less likely to be affected by external noise as compared to when sending analog signals. As a result, the operation device 1 has high accuracy in detecting the operating finger of the user.

The contact detection unit 3 is not limited to the touch sensor and may be a pressure sensor, etc., that detects contact with the operation knob 2, as a modification.

### Configuration of the Operation Detection Unit 4

As shown in FIG. 1B, the operation detection unit 4 has a rod 41, a rod 42, a switch 43 and a switch 44. The rod 41 and the rod 42 are in contact with protrusions provided inside the operation knob 2 and are also in contact with the switch 43 and the switch 44. The switch 43 and the switch 44 are configured to be turned into a first ON state and a second ON state via the rod 41 and the rod 42 by a push-down operation or a pull-up operation performed on the operation knob 2.

Each of the switch 43 and the switch 44 is composed of two switches, as an example. As shown in FIG. 1B, the switch 43 and the switch 44 are arranged in an arrangement recess 121 provided on a bottom surface 120 of the recessed portion 12 of the main body 10.

The operation detection unit 4 is configured to detect a manual operation of continuously opening or closing during when a push-down operation or a pull-up operation continues, and an automatic operation of fully opening or fully closing based on a push-down operation or a pull-up operation performed by not less than a predetermined operation amount.

In particular, when the operation knob 2 is pulled up, a first switch of the switch 43 is firstly turned into the ON state (the first ON state). When the operation knob 2 is further pulled up, the first switch and a second switch of the switch 43 are turned into the ON state (the second ON state). Likewise, when the operation knob 2 is pushed down, a first switch of the switch 44 is firstly turned into the ON state (the first ON state). When the operation knob 2 is further pushed down, the first switch and a second switch of the switch 44 are turned into the ON state (the second ON state).

A mode when the operation knob 2 is pulled up and the switch 43 is turned to the first ON state is a manual mode in which the window is driven closed. A mode when the operation knob 2 is further pulled up and the switch 43 is turned to the second ON state is an automatic mode in which the window is driven until fully closed.

A mode when the operation knob 2 is pushed down and the switch 44 is turned to the first ON state is the manual mode in which the window is driven open. A mode when the operation knob 2 is further pushed down and the switch 44 is turned to the second ON state is the automatic mode in which the window is driven until fully opened.

The manual operation is an operation of driving the windows in the manual mode. The automatic operation is an operation of driving the windows in the automatic mode.

The operation detection unit 4, when detected pulling-up of the operation knob 2, outputs a switch signal S₆ corresponding to the ON state from the switch 43 to the electrically connected control unit 6. Meanwhile, the operation detection unit 4, when detected pushing-down of the operation knob 2, outputs a switch signal S₇ corresponding to the ON state from the switch 44 to the electrically connected control unit 6.

### Configuration of a Storage Unit 5

A storage unit 5 is electrically connected to the control unit 6. The storage unit 5 may be an external storage device connected outside the control unit 6, or may be a RAM of the control unit 6 or a semiconductor memory provided on a main substrate 13. Association information 50 and condition information 51 (described later) are stored in the storage unit 5.

### Configuration of the Control Unit 6

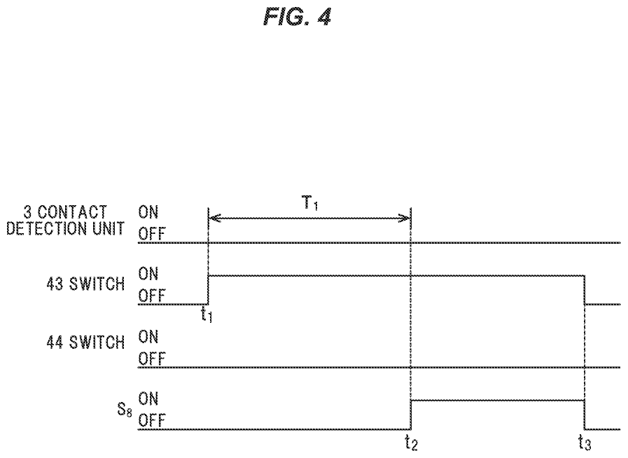

FIG. 4 is an explanatory diagram for explaining the predetermined operation. In FIG. 4, the horizontal axis is time t. In FIG. 4, “ON” for the contact detection unit 3 indicates that the operating finger is detected, and “OFF” indicates no detection. In addition, in FIG. 4, “ON” indicates that a push-down operation (the switch 44) or a pull-up operation (the switch 43) is detected by the operation detection unit 4, and “OFF” indicates the operation not detected thereby. Furthermore, in FIG. 4, “ON” for operation information S₈ indicates that it is output, and “OFF” indicates no output.

The control unit 6 is a microcomputer composed of a CPU performing calculation and processing, etc., of the acquired data according to a stored program, and a RAM and a ROM as semiconductor memories, etc. The ROM stores a program for operation of the control unit 6. The RAM is used as a storage area to temporarily store calculation results, etc. The control unit 6 also has, inside thereof, a means to generate a clock signal and operates based on the clock signal.

As described above, plural detection areas (the first to fourth detection areas 310-340) corresponding to the plural windows (the windows 81a-84a) of the vehicle 8 which can be driven open and closed are set on the one operation knob 2 of the operation device 1. The control unit 6 is configured to control the power window device 7, according to a combination of a detection area in which contact has been detected and a push-down operation or a pull-up operation performed on the operation knob 2, to drive open or close a window corresponding to said detection area.

Meanwhile, when, within a predetermined period, touch operations on plural detection areas are detected and a push-down operation or a pull-up operation is also performed, the control unit 6 controls the power window device 7 to drive open or close windows corresponding to said detection areas. By performing touch operations on plural detection areas corresponding to windows intended to be opened or closed and also performing a push-down operation or a pull-up operation on the operation knob 2 within the predetermined period, the user can serve to drive the desired plural windows.

To drive open or close all the windows, a push-down operation or a pull-up operation may he performed after performing a double-tap operation on at least one detection area, or a push-down operation or a pull-up operation may he performed after touching all detection areas as if tracing over them, but it is not limited thereto.

The predetermined period is a period from when the touch operation is first detected to when a push-down operation or a pull-up operation is detected. The predetermined period is preferably set within a range of not less than is and not more than 3 s, and is more preferably set within a range of not less than is and not more than 2 s, as an example.

Here, when the predetermined operation on the operation knob 2 is detected while contact remains undetected, the control unit 6 operates as follows.

When the predetermined operation on the operation knob 2 is detected while contact remains undetected, the control unit 6 controls the power window device 7 to drive open or close a window on a side where the operation knob 2 is arranged.

This predetermined operation is a push-down operation or a pull-up operation that continues for not less than time T₁. The time T₁ is, e.g., not less than time the window takes fully close from the fully opened state. Thus, the time T₁ is preferably not less than 7 s, more preferably not less than 5 s, as an example.

In particular, as shown in FIG. 4, when the switch 43 is turned “ON” and a pull-up operation in the manual mode is detected at time t₁ based on the switch signal S₆ and the switch signal S₇ acquired from the operation detection unit 4 and contact is undetected based on the detection signal S₅ acquired from the contact detection unit 3, the control unit 6 measures time from the time t₁. Then, when the measured time becomes not less than the time the control unit 6 selects, from a combination of a detection area controllable by the operation knob 2 and the operation performed thereby, opening of the window on the side where the operation knob 2 is arranged, and outputs the corresponding operation information S₈. This opening is performed while the operation continues (time t₂ to time t₃), i.e., in the manual mode.

Since the operation device 1 in the first embodiment is arranged on the right front door 81, the window on the side where the operation knob 2 is arranged is the right front window 81a. Since the user is a driver, the window 81a is driven as a window close to the driver's seat.

When the operation device 1 is arranged on, e.g., the left front door 82, the left front window 82a is selected as the window on the side where the operation knob 2 is arranged. When the operation device 1 is arranged in location other than the door, such as on a floor console of the vehicle 8, a window close to a predetermined seat where the operation device 1 is supposed to be used is the window on the side where the operation knob 2 is arranged. That is, a window close to a seat (user's seat) in which the user is seated is driven.

When an automatic operation is detected as the predetermined operation, the control unit 6 controls the power window device 7 as the manual operation so that a window to be opened or closed is driven open or closed during when the push-down operation or the pull-up operation continues. In this case, when the automatic operation is detected continuously for not less than the time T₁, the control unit 6 drives the window in the manual mode, not in the automatic mode.

The association information 50 stored in the storage unit 5 is information that associates a detection area and a performed operation with operation information S₈ output according to a combination thereof. The control unit 6 selects the operation information S₈, which corresponds to the detection area in which the contact has been detected and the operation performed on the operation knob 2, from the association information 50 and outputs it.

Meanwhile, the condition information 51 stored in the storage unit 5 is information about the predetermined operation and the time T₁. When the operation knob 2 is operated in a state in which contact is undetected, the control unit 6 monitors whether duration of the operation is not less than the time T₁ based on the condition information 51.

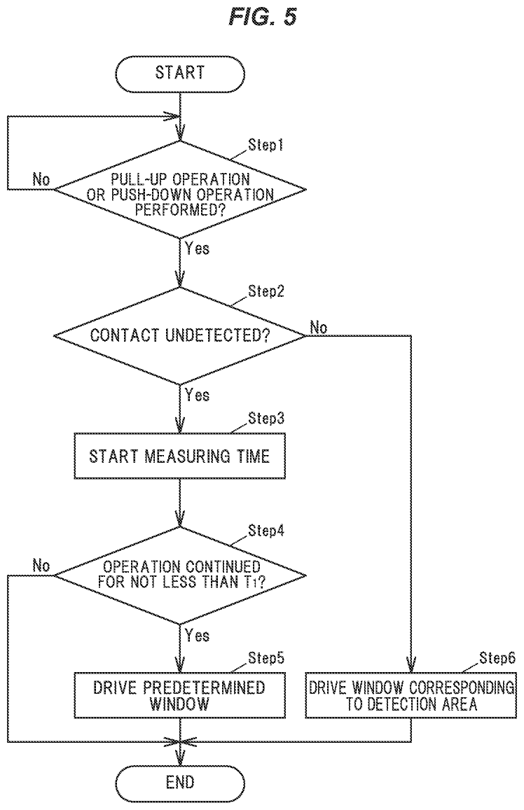

Next, an operation of the operation device 1 in the first embodiment will be described with reference to the flowchart of FIG. 5.

### Operation

The control unit 6 of the operation device 1 monitors an operation based on the detection signal S₅ output from the contact detection unit 3 and the switch signal S₆ and the switch signal S₇ output from the operation detection unit 4. When it is “Yes” in Step 1, i.e., when a pull-up operation or a push-down operation is detected based on the switch signal S₆ and the switch signal S₇ (Step 1: Yes), the control unit 6 checks whether contact is made.

When contact is undetected based on the detection signal S₅ (Step 2: Yes), the control unit 6 starts measuring time (Step 3).

When the operation continues for not less than the time T₁ based on the condition information 51 (Step 4: Yes), the control unit 6 outputs the operation information S₅ to drive open or close a predetermined window, to the power window device 7 (Step 5). The control unit 6 drives the window in the manual mode, regardless of whether the performed operation is the manual operation or the automatic operation. In this regard, the predetermined window is a window on the side where the operation knob 2 is arranged, i.e., a window close to a seat (user's seat) in which the user is seated.

When contact is detected in Step 2 (Step 2: No), the control unit 6 drives a window corresponding to the detection area in which contact has been detected (Step 6).

When the operation does not continue for not less than the time T₁ in Step 4, i.e., when the operation is ended before the elapse of the time T₁ (Step 4: No), the control unit 6 ends the operation without driving the window.

### Effects of the First Embodiment

The operation device 1 in the first embodiment can suppress a decrease in convenience. In particular, other than failure of the contact detection unit 3, operating the operation knob 2 while wearing thick gloves, etc., may also cause no detection of contact since capacitance generated between the user and the detection electrode is small. However, when the operation on the operation knob 2 continues for not less than the time the operation device 1 drives open or close the window of the user's seat even when contact is undetected. Therefore, it is possible to suppress a decrease in convenience as compared to when such a configuration is not adopted.

When the operation knob 2 is operated while contact remains undetected, the operation device 1 drives the window in the manual mode regardless of whether the operation performed on the operation knob is the manual operation or the automatic operation as long as the operation is continuously performed for not less than the time T₁. Therefore, it is possible to suppress opening or closing of a window not intended by the user, as compared to when such a configuration is not adopted.

The operation device 1 can instruct to drive open or close the windows 81a-84a by one operation knob 2. Therefore, it is easy to reduce the size and operability is excellent as compared to when four operation knobs are provided.

### Second Embodiment

The second embodiment is different from the other embodiments in that the predetermined operation is a predetermined procedure.

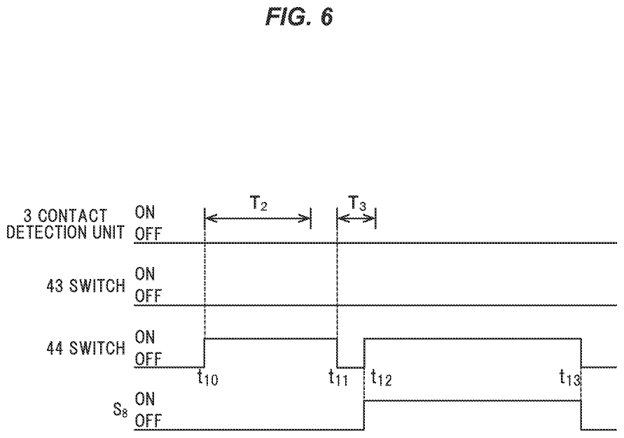

FIG. 6 is an explanatory diagram for explaining the predetermined operation, In FIG. 6, the horizontal axis is time t. In FIG. 6, “ON” for the contact detection unit 3 indicates that the operating finger is detected, and “OFF” indicates no detection. In addition, in FIG. 6, “ON” indicates that a push-down operation (the switch 44) or a pull-up operation (the switch 43) is detected by the operation detection unit 4, and “OFF” indicates the operation not detected thereby. Furthermore, in FIG. 6, “ON” for the operation information S₈ indicates that it is output, and “OFF” indicates no output. In the embodiments described below, portions having the same functions and configurations as those in the first embodiment are denoted by the same reference signs as those in the first embodiment, and the description thereof will be omitted.

The predetermined operation in the second embodiment is an operation following a predetermined procedure. This operation following the predetermined procedure is set on the assumption that the user retries the operation because the window is not driven.

The predetermined procedure in the second embodiment is a procedure in which a pull-up operation or a push-down operation on the operation knob 2 is continued for not less than time T₂ while contact remains undetected, and after the operation is ended, the same operation is started again within time T₃. The time T₂ is preferably not less than 5 s, more preferably not less than 3 s, as an example. The time T₃ is preferably within 3 s, more preferably within is, as an example. The condition information 51 is information about this procedure, the time T₂ and the time T₃.

In particular, as shown in FIG. 6, when the switch 44 is turned “ON” and a push-down operation in the manual mode is detected at time t₁₀ based on the switch signal S₆ and the switch signal S₇ acquired from the operation detection unit 4 and contact is undetected based on the detection signal S₅ acquired from the contact detection unit 3, the control unit 6 measures time from the time t₁₀. Then, when the measured time becomes not less than the time T₂ and the operation is then ended at time t₁₁, the control unit 6 measures time again. When the push-down operation is detected again at time t₁₂ which is within the time T₃, the control unit 6 outputs the operation information S₈ to close the window on the side where the operation knob 2 is arranged. This opening is performed while the operation continues (time t₁₂ to time t₁₃), i.e., in the manual mode.

The predetermined procedure may be, e.g., any combination of multiple operations and, as modifications, may be a procedure in which a push-down operation or a pull-up operation is performed not less than twice consecutively within a certain time, or a procedure in which a push-down operation or a pull-up operation is performed several times in a short time and then a push-down operation or a pull-up operation is performed within a certain period of time, but it is not limited thereto.

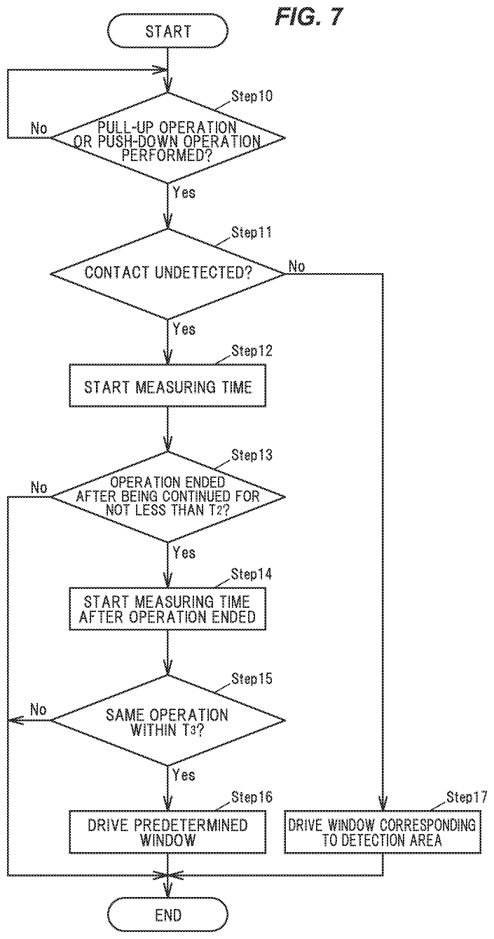

Next, an operation of the operation device 1 in the second embodiment will be described with reference to the flowchart of FIG. 7.

### Operation

The control unit 6 of the operation device 1 monitors an operation based on the detection signal S₅ output from the contact detection unit 3 and the switch signal S₆ and the switch signal S₇ output from the operation detection unit 4. When it is “Yes” in Step 10, i.e., when a pull-up operation or a push-down operation is detected based on the switch signal S₆ and the switch signal S₇ (Step 10: Yes), the control unit 6 checks whether contact is made.

When contact is undetected based on the detection signal S₅ (Step 11: Yes), the control unit 6 starts measuring time (Step 12).

When the operation continues for not less than the time T₂ based on the condition information 51 and the operation is then ended (Step 13: Yes), the control unit 6 measures time from the end of the operation (Step 14).

When the same operation is performed within the time T₃ based on the condition information 51 (Step 15: Yes), the control unit 6 outputs the operation information S₈ to drive open or close a predetermined window, to the power window device 7 (Step 16). The control unit 6 drives the window in the manual mode, regardless of whether the performed operation is the manual operation or the automatic operation. In this regard, the predetermined window is a window on the side where the operation knob 2 is arranged, i.e., a window close to a seat (user's seat) in which the user is seated.

When contact is detected in Step 11 (Step 11: No), the control unit 6 drives a window corresponding to the detection area in which contact has been detected (Step 17).

When the operation does not continue for not less than the time T₂ in Step 13 (Step 13: No), the control unit 6 ends the operation.

Furthermore, when the same operation is not performed within the time T₃ in Step 15 (Step 15: No), the control unit 6 ends the operation.

### Effects of the Second Embodiment

When the operation knob 2 is operated in accordance with the procedure that is set on the assumption that the user retries, the operation device 1 in the second embodiment can serve to drive open or close the window of the user's seat even when contact remains undetected. Therefore, it is possible to suppress a decrease in convenience as compared to when such a configuration is not adopted.

### Third Embodiment

The third embodiment is different from the other embodiments in that the predetermined operation is an operation that continues for not less than a predetermined time, or an operation following with a predetermined procedure.

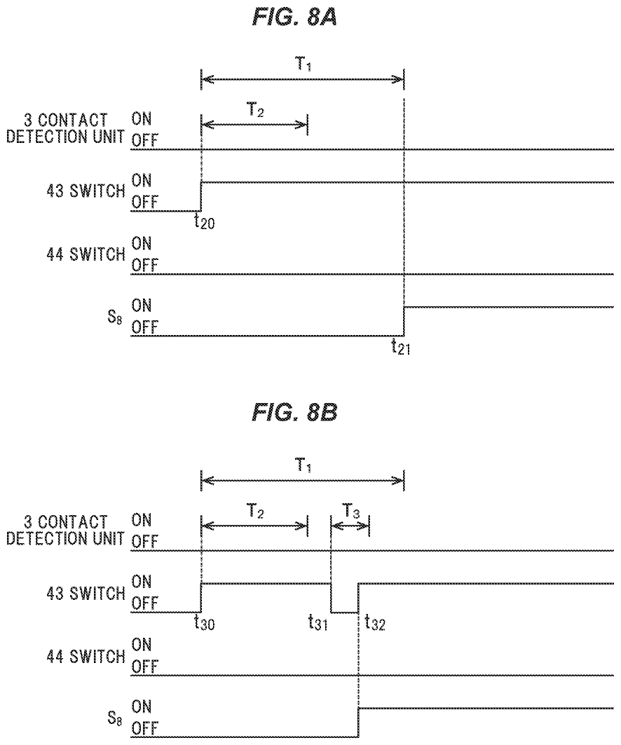

FIG. 8A is an explanatory diagram illustrating that the predetermined operation is an operation that continues for not less than a predetermined time, and FIG. 8B is an explanatory diagram illustrating an operation following a predetermined procedure. In FIGS. 8A and 8B, the horizontal axis is time t. In FIGS. 8A and 8B, “ON” for the contact detection unit 3 indicates that the operating finger is detected, and “OFF” indicates no detection. In addition, in FIGS. 8A and 8B, “ON” indicates that a push-down operation (the switch 44) or a pull-up operation (the switch 43) is detected by the operation detection unit 4, and “OFF” indicates the operation not detected thereby. Furthermore, in FIGS. 8A and 8B, “ON” for the operation information S₈ indicates that it is output, and “OFF” indicates no output.

As shown in FIG. 8A, when the operation on the operation knob 2 continues for not less than the time T₁, the control unit 6 in the second embodiment drives open or close the window of the seat of the user operating the operation knob 2 even if contact is undetected.

In FIG. 8A. since a pull-up operation continues for not less than the time T₁ after being detected at time t₂₀, the opening/closing of the window of the user's seat is started at time t₂₁ at which the time T₁ elapsed.

As shown in FIG. 8B, when a pull-up operation is performed on the operation knob 2 for a not less than the time T₂ and less than the time T₁ and the same operation is then detected again within the time T₃ , the control unit 6 also drives open/close the window of the seat of the user operating the control knob 2 even if contact is undetected.

In FIG. 8B, after the operation is detected at time T₃₀, the operation is ended at time t₃₁ which is not less than the time T₂ and less than the time T₁, the same operation is then started again from the time t₃₂ within the time T₃, and the opening/closing of the window of the user's seat is started at time t₃₂.

### Effects of the Third Embodiment

The operation device 1 in the third embodiment drives open or close the window of the user's seat upon either an operation that continues for not less than a predetermined time, or an operation following a predetermined procedure. Therefore, it is possible to further suppress a decrease in convenience as compared to when such a configuration is not adopted.

The operation device 1 can serve to drive the window within a time shorter than the time T₁ when the operation following a predetermined procedure is performed by the user.

### Fourth Embodiment

The fourth embodiment is different from the other embodiments in that the operation device includes plural operation knobs.

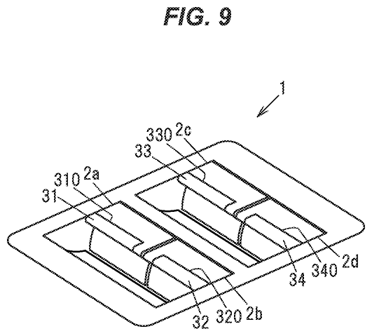

FIG. 9 is an explanatory diagram illustrating the operation device that includes plural operation knobs. This operation device 1 has at least one operation knob on which at least one detection area is set.

In particular, as shown in FIG. 9, the operation device 1 includes first to fourth operation knobs 2a 2d as the at least one operation knob. One detection area is set on each of the first to fourth operation knobs 2a-2d. The detection areas are the first to fourth detection areas 310-340.

The operation detection unit 4 is configured such that the switch 43 and the switch 44 are provided for each of the first to fourth operation knobs 2a-2d.

When, e.g., the predetermined operation on the first operation knob 2a is detected while contact remains undetected, the control unit 6 drives open or close the window corresponding to the first operation knob 2a.

### Effects of the Fourth Embodiment

When the operation performed on any of the first to fourth operation knobs 2a-2d is the predetermined operation, the operation device 1 in the fourth embodiment drives open or close the window corresponding to the operated operation knob even if contact is undetected. Therefore, it is possible to suppress a decrease in convenience as compared to when such a configuration is not adopted.

Although some embodiments and modifications of the invention have been described, these embodiments and modifications are merely examples and the invention according to claims is not to be limited thereto. These new embodiments and modifications thereof may be implemented in various other forms, and various omissions, substitutions and changes, etc., can be made without departing from the gist of the invention. In addition, not all combinations of the features described in these embodiments and modifications are necessary to solve the problem of the invention. Further, these embodiments and modifications thereof are included within the scope and gist of the invention and also within the invention described in the claims and the range of equivalency.

### REFERENCE SIGNS LIST

1 OPERATION DEVICE

2 OPERATION KNOB

3 CONTACT DETECTION UNIT

4 OPERATION DETECTION UNIT

6 CONTROL UNIT

7 POWER WINDOW DEVICE

8 VEHICLE

310-340 FIRST DETECTION AREA to FOURTH DETECTION AREA

1. An operation device, comprising:
at least one operation knob on which at least one detection area is set;
a contact detection unit to detect contact of a user with the at least one detection area;
an operation detection unit to detect an operation performed on the at least one operation knob; and
a control unit that controls a controlled object by a combination of a detection area in which contact has been detected and an operation performed on an operation knob comprising said detection area, and when a predetermined operation on the operation knob is detected while contact remains undetected, the control unit selects a control related to said operation knob from the combination and controls the controlled object.

2. The operation device according to claim 1, wherein the predetermined operation comprises an operation that continues for not less than a predetermined time.

3. The operation device according to claim 1, wherein the predetermined operation comprises an operation following with a predetermined procedure.

4. The operation device according to claim 1, wherein a plurality of detection areas corresponding to a plurality of windows of a vehicle which can be driven open and closed are set on one operation knob, and wherein by a combination of a detection area in which contact has been detected and a push-down operation or a pull-up operation performed on the operation knob, the control unit controls the controlled object to drive open or close a window corresponding to said detection area.

5. The operation device according to claim 1, wherein a plurality of detection areas corresponding to a plurality of windows of a vehicle which can be driven open and closed are respectively combined with and set on a plurality of operation knobs, and wherein according to a detection area in which contact has been detected and a push-down operation or a pull-up operation performed on the operation knob on which said detection area is set, the control unit controls the controlled object to drive open or close a window corresponding to said detection area and the operation knob.

6. The operation device according to claim 4, wherein when the predetermined operation on the operation knob is detected while contact remains undetected, the control unit controls the controlled object to drive open or close a window on a side where the operation knob is arranged.

7. The operation device according to claim 1, wherein the control unit detects the push-down operation or the pull-up operation for not less than the predetermined time as the predetermined operation.

8. The operation device according to claim 1, wherein the control unit detects, as the predetermined operation, an operation following a procedure in which, after the push-down operation or the pull-up operation for not less than a predetermined second time is ended, the push-down operation or the pull-up operation is started again within a predetermined third time.

9. The operation device according to claim 1, wherein the control unit detects, as the predetermined operation, an operation following a procedure in which the push-down operation or the pull-up operation is performed not less than twice consecutively within a certain time.

10. The operation device according to claim 4, wherein the operation detection unit is configured to detect a manual operation of continuously opening or closing during when the push-down operation or the pull-up operation continues, and an automatic operation of fully opening or fully closing based on the push-down operation or the pull-up operation performed by not less than a predetermined operation amount, and wherein when the automatic operation is detected as the predetermined operation, the control unit controls the controlled object as the manual operation so that a window to be opened or closed is driven open or closed during when the push-down operation or the pull-up operation continues.
